(19) United States
(12) Patent Application Publication
(10) Pub. No.: US 2009/0164041 A1
(43) Pub. Date: Jun. 25, 2009

(54) SYSTEM FOR ZONAL WAREHOUSING MANAGEMENT

(75) Inventor: Liying GENG, Beijing (CN)

Correspondence Address: YING CHEN;Chen Yoshimura LLP, 255 S. GRAND AVE., # 215, LOS ANGELES, CA, 90012, US

(73) Assignee: Beijing Aotengxunda Science and Technology Co., Ltd., Beijing (CN)

(21) Appl. No.: 11/964,044

(22) Filed: Dec. 25, 2007

(30) Foreign Application Priority Data
Dec. 24, 2007 (CN) 200710303981.7

(51) Int. Cl. G06F 7/00; G06F 17/30

(52) U.S. Cl. 700/215; 700/214; 707/104.1; 707/E17.001; 707/E17.009

(57) ABSTRACT

The present invention discloses a system for zonal warehousing management, which comprises a central processing system and a data collection terminal which exchanges data with the central processing system. The said data collection terminal collects the in/out warehouse data of kinds of goods and then sends them to the central processing system for statistics, analysis and storage. The said central processing system includes real-time storage database, warehouse zone database and a location assignment unit, wherein the warehouse zone database stores the data of the goods zonal warehouse management capacity and the location in use of the managed warehouse, and the location assignment unit reads the above data according to the characteristic data of the goods in/out warehouse to assign corresponding zone location for the goods in warehouse. Optimization controls to storage method, storage quantity and storage time are made according to the management condition of enterprises. When optimization question appears, alarm is produced. Therefore, the system promotes the management level of the enterprise.

### TECHNICAL FIELD

The present invention relates to the technology field of the computer information, and more particularly, to a system for zonal warehousing management.

### BACKGROUND

At present, kinds of computer warehousing management system are mainly based on the management of in/out warehouse. The zones of various goods are assigned manually without the optimization of location assignment in the warehouse, which results in the jam and waste of the warehouse location because of the irrational location assignment.

### SUMMARY

In order to overcome the above disadvantages, the present invention provides a system for zonal warehousing management, which realizes not only the collection and statistic of the stored data, but also the zonal management of the warehouse according to the characteristic of the warehouse. It can assign a rational location for the goods at any time, which can utilize the warehouse efficiently, promote the storage quantity and save in/out warehouse cost.

The present invention discloses a system for zonal warehousing management, which comprises a central processing system and a data collection terminal which exchanges data with the central processing system. The data collection terminal collects the in/out warehouse data of kinds of goods and then sends them to the central processing system for statistic, analysis and storage. The said central processing system includes real-time storage database, warehouse zone database and a location assignment unit, wherein the warehouse zone database stores the data of the goods zonal warehouse management capacity and the location in use of the managed warehouse, and the location assignment unit reads the above data according to the characteristic data of the goods in/out warehouse to assign corresponding zone location for the goods in warehouse.

The central processing system further includes data statistic unit, data comparison and analysis unit, data storage and output unit, manual input device and central control unit. The data statistic unit is used for acquiring the data of kinds of goods in/out warehouse, which is collected by the data collection terminal, reading the corresponding data in the real-time storage database and statistics them to get the data for the storage quantity, in/out time and the goods characteristics, etc. Then these data is sent to the real-time storage database by the data storage and output unit. The data comparison and analysis unit reads the above data from the real-time storage database, and the optimization program and parameters of the stored optimized data for optimization calculation. When the storage quantity is beyond the upper limit, the excessive signal is produced; when the storage quantity is less than the lower limit, the shortage signal is produced; when the storage time of the stored goods reaches the alarm time, the storage alarm signal is produced. These signals are sent to the storage optimization unit through the data storage and output unit to display. The data storage and output unit is used for sending the data from the data statistic unit, data comparison and analysis unit and manual input device to corresponding database for storage, or reading the data in corresponding database according to the instructions from the data statistic unit, data comparison and analysis unit as well as manual input device to display the data. The said central control unit controls the coordination between the data statistic unit, data comparison and analysis unit, the data storage and output unit and manual input device.

Automation and optimization of the enterprise warehouse are two aspects of the present system. Except the ordinary automation of the warehouse management system, the optimization analysis to the storage and the optimization control to the storage quantity and storage time are realized. When the storage is excessive or insufficient or the storage time is too long, alarm will be produced to tell the manager to deal it in time. Therefore, the system promotes the management level of the enterprise, decreases the cost and risk of the warehouse, and reduces fund. The optimization method can be adjusted and modified in time according to the manual input. Therefore, the optimization mode can be changed when the internal management or the external market of the enterprise changes to obtain the best optimization effect. Otherwise, the simple hardware required by the management system, low cost, high automation and good flexibility are the advantages of this system, which can implement optimization analysis without increasing the workload of the operator, which is good for extension application.

### BRIEF DESCRIPTION OF THE DRAWINGS

The accompanying drawings, which are incorporated in and constitute a part of specification, illustrate an exemplary embodiment of the present invention and, together with the general description given above and the detailed description of the preferred embodiment given below, serve to explain the principles of the present invention.

FIG. 1 illustrates the structure schematic diagram of the present invention.

### DETAILED DESCRIPTION

While the claims are not limited to the illustrated embodiments, an appreciation of various aspects of the present invention is best gained through a discussion of various examples thereof. Referring now to the drawings, illustrative embodiments will be described in detail. Although the drawings represent the embodiments, the drawings are not necessarily to scale and certain features may be exaggerated to better illustrate and explain an innovative aspect of an embodiment. Further, the embodiments described herein are not intended to be exhaustive or otherwise limiting or restricting to the precise form and configuration shown in the drawings and disclosed in the following detailed description.

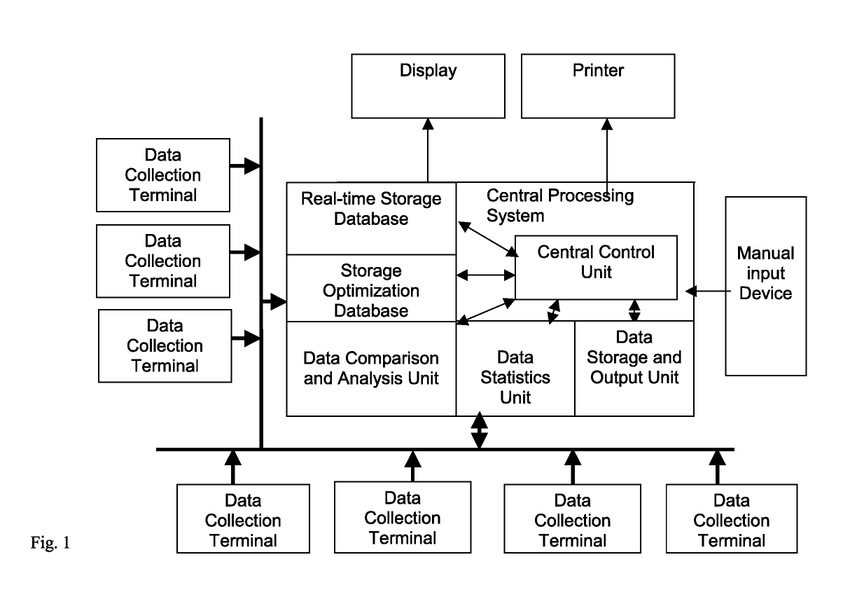

With reference to FIG. 1, a system for zonal warehousing management is provided, which comprises a central processing system and a data collection terminal which exchanges data with the central processing system. The data collection terminal collects the in/out warehouse data of kinds of goods and then sends them to the central processing system which statistic, analyzes and stores these data. The said central processing system includes real-time storage database, warehouse zone database and a location assignment unit, wherein the warehouse zone database stores the data of the goods zonal warehouse management capacity and the location in use of the managed warehouse, and the location assignment unit reads the above data according to the characteristic data of the goods in/out warehouse to assign corresponding zone location for the goods in warehouse.

The central processing system further includes real-time storage database, storage optimization database, data statistic unit, data comparing and analysis unit, data storage and output unit, manual input device and central control unit. The data statistic unit is used for acquiring the data of kinds of goods in/out warehouse, which is collected by the data collection terminal, reading the corresponding data in the real-time storage database and then statistic calculation is made to get the data for the storage quantity, in/out time and the goods characteristics, etc. Then the above data is sent to the real-time storage database by the data storage and output unit. The data comparison and analysis unit reads the above data from the real-time storage database, and the optimization program and parameters of the stored optimized data for optimization calculation. When the storage quantity is beyond the upper limit, the excessive signal is produced; when the storage quantity is less than the lower limit, the shortage signal is produced; when the storage time of the stored goods reaches the alarm time, the storage alarm signal is produced. These signals are sent to the storage optimization unit through the data storage and output unit to display. The data storage and output unit is used for sending the data from the data statistic unit, data comparison and analysis unit and manual input device to corresponding database for storage, or reading the data in corresponding database according to the instructions from the data statistic unit, data comparison and analysis unit as well as manual input device to display the data. The said central control unit controls the coordination between the data statistic unit, data comparison and analysis unit, the data storage and output unit and manual input device.

Computer information processing is the main management means of the present system, which can realize the automatic warehousing management of various enterprises, especially the large industry one and the commercial one. The hardware part of the computer system includes several data collection terminals for the in/out goods and the central processing system, and the location zone of the warehouse is divided into several zones. The said data collection terminals collect the in/out goods information, and then send them to the central processing system. When the goods is entering the warehouse, the central processing system determines the storage zone and assign location for the goods, and sends storage instruction to the operator or the automatic transport device, and stores the entry goods data into the real-time storage database; When the goods is exiting the warehouse, the instructions is output to the central processing system in manual or mechanical manner. The central processing system reads the data in the real-time storage database, and determines the location of the goods according to the first-in first-out manner, and sends extracting instructions to the operator or the automatic transport device. The data of goods, which is sent from the data collection terminal, is recorded to the real-time storage database. The collection of the information is completed by using the mobile or fixed bar code recognizer and manual output based on the actual condition of various goods. The mobile bar code recognizer communicates with the central processing system in wire or wireless manner. A display screen set on the mobile bar code recognizer displays the read information of bar code and storage management. Further, a manual input device is set for outputting the information manually. The said central processing system further includes a network controller which communicates with the central processing system and bar code recognizer respectively in wire or wireless manner, by transferring the information from the central processing system to the bar recognizer and the information collected by the bar code recognizer to the central processing system. The network controller includes wire network connected port, and the network controller connects with the said central processing system through the wire network connected port set on it and the wire network, to transform and optimize the communication protocol between the central processing system and the mobile bar code recognizer. The central processing system obtains the information from the mobile bar code recognizer and sends the storage management information to the mobile bar code recognizer by the network controller. The central processing system communicates with the network controller using the TCP/IP protocol. Multiple network controllers can be arranged and each one connects with one or more central processing system. According to the specific case of enterprises, the said warehouse location can be divided into the direct zone, intermediate zone and long-time zone, wherein plane shelves are arranged in the direct zone, the solid shelves are arranged in the intermediate zone, and the gravity shelf are arranged in the long-time zone.

Optimization of the storage is realized by the central processing system, which includes the optimization of the storage quantity as well as the storage time. Appropriate controlling upper limit and lower limit of the storage quantity and time are set for various goods according to the case of the enterprises users. When the corresponding value is beyond the controlling line, alarm is produced automatically. The controlling line is set based on the client's experience and the analysis of the management data, which can be modified manually by the client temporarily or permanently by need. For the industry enterprise and other enterprise in need, the management system acquires the production or sale information in data exchange and manual input manner to calculate and modifies the control line according to the set manner. The arrangement of the data interface makes it possible to form uniform economic management system.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A system for zonal warehousing management, comprising a central processing system and a data collection terminal which exchanges data with the central processing system; the data collection terminal collects the in/out warehouse data of kinds of goods and then sends them to the central processing system for statistic, analysis and storage; the said central processing system includes real-time storage database, warehouse zone database and a location assignment unit; wherein the warehouse zone database stores the data of the goods zonal warehouse management capacity and the location in use of the managed warehouse, and the location assignment unit reads the above data according to the characteristic data of the goods in/out warehouse to assign corresponding zone location for the goods in warehouse.

2. The system for zonal warehousing management as claimed in claim 1, wherein further comprises storage optimization database, data statistic unit, data comparing and analysis unit, data storage and output unit, manual input device and central control unit; the data statistic unit is used for acquiring the data of kinds of goods in/out warehouse, which is collected by the data collection terminal, reading the corresponding data in the real-time storage database and then statistical calculation is made to get the data for the storage quantity, in/out time and the goods characteristics, etc; then the said data is sent to the real-time storage database by the data storage and output unit; the data comparison and analysis unit reads the above data from the real-time storage database, and the optimization program and parameters of the stored optimized data for optimization calculation; when the storage quantity is beyond the upper limit, the excessive signal is produced; when the storage quantity is less than the lower limit, the shortage signal is produced; when the storage time of the stored goods reaches the alarm time, the storage alarm signal is produced; these signal are sent to the storage optimization unit through the data storage and output unit to display; the data storage and output unit is used for sending the data from the data statistic unit, data comparison and analysis unit and manual input device to corresponding database for storage, or reading the data in corresponding database according to the instructions from the data statistic unit, data comparison and analysis unit as well as manual input device to display the data; the said central control unit controls the coordination between the data statistic unit, data comparison and analysis unit, the data storage and output unit and manual input device.

3. The system for zonal warehousing management as claimed in claim 2, wherein the said data collection terminals collect the in/out goods information, and then send them to the central processing system; when the goods is entering the warehouse, the central processing system determines the storage zone and assign location for the goods, and sends storage instruction to the operator or the automatic transport device, and stores the entry goods data into the real-time storage database; when the goods is exiting the warehouse, the instructions is output to the central processing system in manual or mechanical manner; the central processing system reads the data in the real-time storage database, and determines the location of the goods according to the first-in first-out manner, and sends extracting instructions to the operator or the automatic transport device; the goods data sent from the data collection terminal is recorded to the real-time storage database.

4. The system for zonal warehousing management as claimed in claim 1, wherein the said collection of the information is completed by using the mobile or fixed bar code recognizer and manual output based on the condition of various goods.

5. The system for zonal warehousing management as claimed in claim 4, wherein the said data collection terminal communicates with the central processing system in wire or wireless manner.

6. The system for zonal warehousing management as claimed in claim 5, wherein the said data collection terminal utilizes mobile bar code recognizer which has display screen and manual input device set on, and the said display screen displays the read information of bar code and storage management; a manual input device is also set for outputting information manually.

7. The system for zonal warehousing management as claimed in claim 6, wherein the said central processing system further includes a network controller which communicates with the central processing system and bar code recognizer respectively in wire or wireless manner for transferring the information from the central processing system to the bar recognizer and the information collected by the bar code recognizer to the central processing system.

8. The system for zonal warehousing management as claimed in claim 7, wherein the said network controller has wire network connected port set on it, and the network controller connects with the said central processing system through the wire network connected port and wire network to transform and optimize the communication protocol between the central processing system and the mobile bar code recognizer.

9. The system for zonal warehousing management as claimed in claim 8, wherein the said central processing system acquires the information from the mobile bar code recognizer and sends the storage management information to the mobile bar code recognizer through the network controller.

10. The system for zonal warehousing management as claimed in claim 9, wherein the said central processing system communicates with the network controller using the TCP/IP protocol.

11. The system for zonal warehousing management as claimed in claim 3, wherein the said collection of the information is completed by using the mobile or fixed bar code recognizer and manual output based on the actual condition of various goods.

12. The system for zonal warehousing management as claimed in claim 11, wherein the said data collection terminal communicates with the central processing system in wire or wireless manner.

13. The system for zonal warehousing management as claimed in claim 12, wherein the said data collection terminal utilizes mobile bar code recognizer which has display screen and manual input device set on, and the said display screen displays the read information of bar code and storage management, a manual input device is also set for outputting information manually.

14. The system for zonal warehousing management as claimed in claim 13, wherein the said central processing system further includes a network controller which communicates with the central processing system and bar code recognizer respectively in wire or wireless manner for transferring the information from the central processing system to the bar recognizer and the information collected by the bar code recognizer to the central processing system.

15. The system for zonal warehousing management as claimed in claim 14, wherein the said network controller has wire network connected port set on it, and the network controller connects with the said central processing system through the wire network connected port and the wire network, to transform and optimize the communication protocol between the central processing system and the mobile bar code recognizer.

16. The system for zonal warehousing management as claimed in claim 15, wherein the said central processing system acquires the information from the mobile bar code recognizer and sends the storage management information to the mobile bar code recognizer through the network controller.

17. The system for zonal warehousing management as claimed in claim 16, wherein the said central processing system communicates with the network controller using the TCP/IP protocol.
